(19) United States
(12) Patent Application Publication
(10) Pub. No.: US 2015/0336463 A1
(43) Pub. Date: Nov. 26, 2015

(54) ACTIVE ELECTROMAGNETIC INTERFERENCE MITIGATION SYSTEM AND METHOD

(71) Applicant: DELPHI TECHNOLOGIES, INC., Troy, MI (US)

(72) Inventors: RICHARD J. BOYER, MANTUA, OH (US); JOHN F. HEFFRON, YOUNGSTOWN, OH (US)

(73) Assignee: DELPHI TECHNOLOGIES, INC., Troy, MI (US)

(21) Appl. No.: 14/283,739

(22) Filed: May 21, 2014

(51) Int. Cl. B60L 11/18

(52) U.S. Cl. CPC B60L 11/182

(57) ABSTRACT

A system and method to mitigate electromagnetic interference generated by a source resonator of a wireless charging system is presented. The system includes a receiver that configured to receive a wireless charging signal transmitted by the source resonator, a phase shifter in communication with the receiver and configured to generate a canceling signal that is 180° out of phase with the wireless charging signal currently received by the receiver, and a transmitter in communication with the phase shifter and configured to electromagnetically transmit the canceling signal, thereby canceling at least a portion of the wireless charging signal. The canceling signal being at the same frequency and 180° out of phase interferes with the charging signal to reduce or eliminate electromagnetic interference in the vicinity of the vehicle being charged.

### TECHNICAL FIELD OF THE INVENTION

The invention generally relates to a system and method for providing active electromagnetic interference cancellation, and more particularly relates to a system and method to reduce electromagnetic interference caused by wireless power transmission systems.

### BACKGROUND OF THE INVENTION

Electric vehicles and electric-hybrid vehicles are gaining in popularity with consumers. The electric motors in these vehicles are typically powered from multiple storage batteries disposed in a battery pack in the vehicle. If the battery needs to be recharged while the vehicle is parked, a wired coupling device is connected to the vehicle, typically by the vehicle operator. However, some operators object to having to ‘plug-in’ their vehicle each time the vehicle is parked to charge the batteries.

Therefore, wireless or connector-less battery chargers have been developed that wirelessly transmit power from a source resonator or charging pad lying on a parking surface under the vehicle being charged to a corresponding capture resonator mounted on the underside of the vehicle that is electromagnetically coupled to the source resonator.

When electric vehicles and electric-hybrid vehicles are being charged wirelessly the electromagnetic power transfer generates electromagnetic interference (EMI) that degrades the performance of the short range radio frequency remote control system that is typically used to lock/unlock the vehicle doors, sometimes referred to as a key fob. This EMI occurs with the remote control system on the vehicle being wirelessly charged and the remote control systems of other vehicles parked in the vicinity of the vehicle being wirelessly charged. The electromagnetic field strength of the wireless charging system fundamental frequency is at a level that renders the remote control system inoperable except at very close range. The convenience of implementing a wireless charging system is hampered by this interference with the remote control system. Various techniques have been tried to alleviate the issue such as:
Deactivation of the wireless charging system when the remote control system is present. This may work with certain remote control systems but does not address problems experienced by the vehicles parked adjacent to the wireless charging system.
Increasing the transmit power of the remote control system transducer so that the signal can activate the remote control system during the wireless charging system charge cycle. This has some potential with certain remote control systems but still does not address the problems created for vehicles parked adjacent to the wireless charging system.
Change the modulation technique used by the remote control system to operate during the wireless charging system operation. Certain modulation techniques are much more immune to this type of interference than others. This may be a viable solution for future remote control systems but does not address existing remote control systems and again does not address the problems created for vehicles parked adjacent to the wireless charging system.

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also be inventions.

### BRIEF SUMMARY OF THE INVENTION

In accordance with one embodiment of this invention, a system that is configured to mitigate electromagnetic interference generated by a source resonator of a wireless charging system is provided. The system includes a receiver configured to receive a wireless charging signal transmitted by the source resonator, a phase shifter in communication with the receiver and configured to generate a canceling signal that is 180° out of phase with the wireless charging signal currently received by the receiver, and a transmitter that is in communication with the phase shifter and is configured to electromagnetically transmit the canceling signal, thereby canceling at least a portion of the wireless charging signal.

The system may further determine a fundamental frequency of the wireless charging signal and the frequency of the canceling signal may be based on the fundamental frequency of the wireless charging signal currently received by the receiver. The transmitter may be a dedicated transmitter configured to transmit only the canceling signal or a transceiver of a remote control system configured to transmit the canceling signal as well as transmit and receive remote control signals. The transmitter and/or receiver may be disposed within a vehicle or within the wireless charging system.

In another embodiment of the present invention, a method to mitigate electromagnetic interference generated by a source resonator of a wireless charging system is provided. The method includes the steps of receiving a wireless charging signal transmitted by the source resonator, generating a canceling signal that is 180° out of phase with the wireless charging signal that is currently being received, and electromagnetically transmitting the canceling signal, thereby canceling at least a portion of the wireless charging signal. The method may further includes the steps of determining a fundamental frequency of the wireless charging signal and transmitting the canceling signal at a canceling signal frequency that is based on the fundamental frequency of the wireless charging signal that is currently being received.

Further features and advantages of the invention will appear more clearly on a reading of the following detailed description of the preferred embodiment of the invention, which is given by way of non-limiting example only and with reference to the accompanying drawings.

### BRIEF DESCRIPTION OF THE SEVERAL VIEWS OF THE DRAWING

The present invention will now be described, by way of example with reference to the accompanying drawings, in which:

FIG. 1 is a schematic diagram of the active electromagnetic interference mitigation system in a vehicle having a wireless charging system and a wireless remote control system in accordance with one embodiment;

FIG. 2 is a schematic diagram of the active electromagnetic interference mitigation system of FIG. 1 in accordance with one embodiment; and

FIG. 3 is flow chart of a method to mitigate electromagnetic interference generated by a source resonator of a wireless charging system in accordance with another embodiment.

### DETAILED DESCRIPTION OF THE INVENTION

A system is presented herein to mitigate electromagnetic interference (EMI) caused by a wireless charging system for electronic components, such as wireless remote control systems, both on and adjacent to a vehicle using a wireless charging system. This invention diminishes or eliminates the EMI generated by the wireless charging system by transmitting a canceling signal at frequency that is the same as the fundamental frequency of the wireless charging system's charging signal and is 180° out of phase with the charging signal. This canceling signal will reduce or eradicate the offending EMI because it is 180° out of phase and will remain 180° out of phase by monitoring the charging signal of the wireless charging system and actively adjusting the phase, frequency, and/or amplitude of the canceling signal to compensate for changes in the charging signal.

This system may be installed on a vehicle which uses a wireless charging system to charge its on-board energy storage device, which is typically a high voltage battery pack. The system will monitor the phase and/or frequency of the electromagnetic charging signal produced by the wireless charging system by either querying the on vehicle components of the wireless charging system or by measuring the charging signal with a dedicated receiver. The information concerning the phase of the charging signal will then be processed by system and a canceling signal will be generated that has the same frequency as the charging signal but is 180° out of phase with the charging signal. This newly generated canceling signal will then be electromagnetically transmitted from the existing remote control transducers on the vehicle or a separate dedicated transmitter. The choice of using the existing remote control transducers or adding a separate dedicated transmitter will be dependent on the actual vehicle system implementation and compatibility with on vehicle remote control system. Typical remote control systems integrate remote control transducers into the driver and passenger door handles. These remote control transducers produce the signal that is transmitted to the remote control key fob of the vehicle operator to initiate the desired remote control function which typically includes locking/unlocking a door. Producing a canceling signal that is 180° out of phase will cancel the adverse effects of EMI from the wireless charging system around the vehicle enabling proper operation of the remote control system.

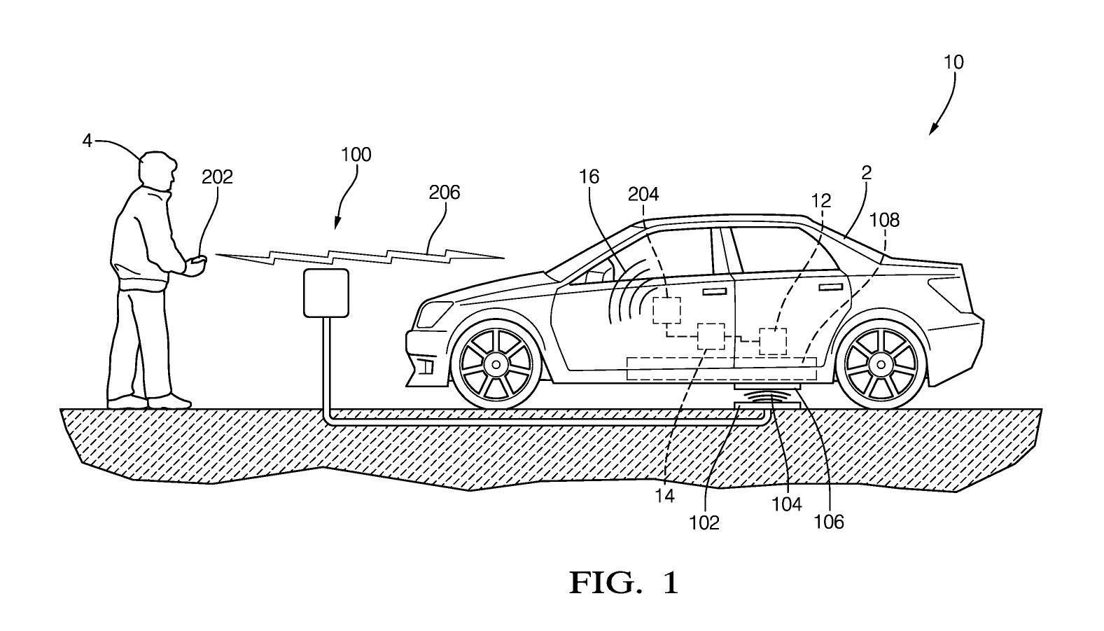

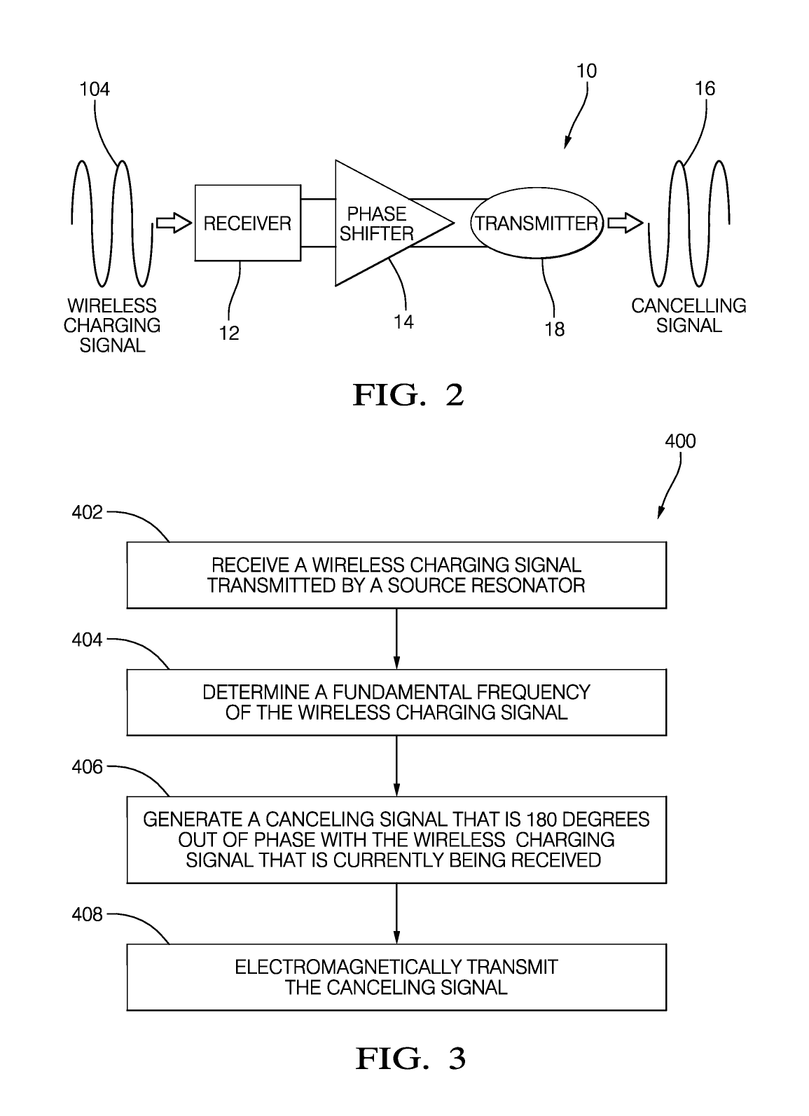

FIG. 1 illustrates a non-limiting example of a system 10 configured to mitigate electromagnetic interference generated by a source resonator 102 of a wireless charging system 100. As illustrated in FIG. 1, the wireless charging system 100 includes a power source (not shown) that is connected to the source resonator 102. The power source converts electrical power from a utility main (not shown) to an alternating current signal, typically in the 85 kilohertz (kHz) range. This alternating current signal then causes the source resonator 102 to generate an electromagnetic wireless charging signal 104 that is transmitted to a capture resonator 106 on the vehicle 2 that is electromagnetically coupled to the source resonator 102. The charging signal 104 induces another alternating current signal in the capture resonator 106 that is used to charge the battery pack 108 in the vehicle 2. The vehicle 2 also includes a remote control system 200 that allows the vehicle 2 to communicate with a remote control device 202, such as a key fob carried by a vehicle operator 4 to remotely control vehicle functions such as locking/unlocking doors, open trunk, remote engine start, etc. The remote control device 202 includes a transceiver (not shown) that is configured to communicate with a corresponding transceiver 204 in the vehicle 2 to establish remote control signals 206 over a wireless communication path between the vehicle 2 and the remote control device 202. The remote control transceiver 204 typically operates in the 125 kHz range.

The electromagnetic interference mitigation system 10 includes a receiver 12 configured to receive the wireless charging signal 104 transmitted by the source resonator 102. The receiver 12 may include the capture resonator 106 and signal processing circuitry of the wireless charging system (not shown) or it may be include a dedicated antenna and dedicated signal processing circuitry (not shown). The signal processing circuitry may include a digital signal processor integrated circuit (IC) (not shown) programmed to determine the fundamental frequency of the charging signal 104 generated by the source resonator 102. As used herein, the fundamental frequency is the frequency around which the peak power of the charging signal 104 is centered. The signal processing circuitry continually determines this fundamental frequency because the frequency may drift during the charging process.

The system 10 further includes a phase shifter 14 that is electrically connected to and in electronic communication with the receiver 12. The phase shifter 14 is configured to analyze the charging signal 104 that is currently received by the receiver 12 and to generate a canceling signal 16 that is 180° out of phase with the wireless charging signal 104. The phase shifter 14 includes signal processing circuitry such as a digital signal processor IC (not shown) that is programmed to determine the phase of the canceling signal 16 or an inverting amplifier that generates the canceling signal 16 from the charging signal 104 received by the receiver 12. The phase shifter 14 may be made up of separate signal processing circuitry or it may be integrated into the signal processing circuitry of the receiver 12.

The system 10 additionally includes a transmitter 18 that is electrically connected to and in electronic communication with the phase shifter 14 and configured to electromagnetically transmit the canceling signal 16. While not subscribing to any particular theory of operation for the system 10, the canceling signal 16 being 180° out of phase with the charging signal 104 interferes with the wireless charging signal 104 in the vicinity of the remote control transceiver 204, thereby canceling at least a portion of the wireless charging signal 104. The transmitter 18 may include an amplifier (not shown) and the gain of this amplifier may be determined by the amplitude of the charging signal 104 detected by the receiver 12. Ideally, the magnitude of the canceling signal 16 matches the amplitude of the charging signal 104 and the phase of the canceling signal 16 is exactly 180° out of phase with the charging signal 104 at the location of the remote control transceiver 204. Determining the desired amplitude of the canceling signal 16 may be based on measurements of the field strength of the wireless charging signal 104 near the remote control transceiver 204 location by the receiver 12 or from measurements made using other instruments well known to those skilled in the art. The desired amplitude of the canceling signal 16 may alternatively or additionally be based on electromagnetic field analysis tools well known to those skilled in the art.

The remote control transceiver 204 of the remote control system 200, because it includes both receive and transmit circuitry could also serve as both the receiver 12 and the transmitter 18 of the EMI mitigation system 10.

As illustrated in FIG. 1, when the vehicle operator 4 approaches the vehicle 2 with the remote control device 202, the EMI from the wireless charging system 100 is greatly reduced in the vicinity of the remote control transceiver 204, allowing proper operation of the remote control system 200. Because the wireless charging system 100 operates at different frequency than the remote control system 200, the remote control transceiver 204 can easily transmit the canceling signal 16 and the remote control signals 206 needed to operate the remote control system 200. Because the canceling signal 16 is transmitted during the entire wireless charging cycle, it reduces the effect of the EMI for vehicles parked adjacent to the wireless charging system 100 also.

While the illustrated embodiment shows the system 10 used with a vehicle based wireless charging system 100, other embodiments of the EMI mitigation system may be envisioned for use with non-vehicle based applications, such as a wireless charging pad for a cellular telephone, tablet computer, or other consumer electronic device that needs to receive wireless signals while charging. Also, although the illustrated embodiment shows the system 10 disposed within a vehicle 2, the EMI mitigation system may alternatively be disposed within the wireless charging system 100. This alternative embodiment provides the benefit of EMI mitigation for any vehicle using the wireless charging system 100, not just vehicles equipped with an EMI mitigation system.

FIG. 3 illustrates non-limiting example of a method 400 to mitigate electromagnetic interference generated by a source resonator 102 of a wireless charging system 100. The method 400 includes the following steps.

STEP 402, RECEIVE A WIRELESS CHARGING SIGNAL TRANSMITTED BY THE SOURCE RESONATOR, includes determining a fundamental frequency of the wireless charging signal 104. The canceling signal 16 is transmitted at a canceling signal frequency that is based on the fundamental frequency of the wireless charging signal 104 that is currently being received.

The optional STEP 404, DETERMINE A FUNDAMENTAL FREQUENCY OF THE WIRELESS CHARGING SIGNAL, includes determining a fundamental frequency of the wireless charging signal 104. The canceling signal 16 is then transmitted at a canceling signal frequency that is based on the fundamental frequency of the wireless charging signal 104 that is currently being received, preferably at the same frequency as the fundamental frequency of the wireless charging signal 104.

STEP 406, GENERATE A CANCELING SIGNAL THAT IS 180 DEGREES OUT OF PHASE WITH THE WIRELESS CHARGING SIGNAL THAT IS CURRENTLY BEING RECEIVED, includes generating a canceling signal 16 that is 180° out of phase with the wireless charging signal 104 that is currently being received.

STEP 408, ELECTROMAGNETICALLY TRANSMIT THE CANCELING SIGNAL, includes electromagnetically transmitting the canceling signal 16, thereby canceling at least a portion of the wireless charging signal 104. Preferably the canceling signal 16 is transmitted at the same frequency as the fundamental frequency of the charging signal 104 being received.

Accordingly, a system 10 configured to mitigate electromagnetic interference generated by a source resonator 102 of a wireless charging system 100 and a method 400 to mitigate electromagnetic interference generated by a source resonator 102 of a wireless charging system 100 are provided. Some of the benefits provided by the system 10 are using existing components in vehicle 2 that are in the correct position to eliminate the interference where it is needed most, at the location of the vehicle operator 4 with the remote control device 202. The system 10 and method 400 solve the EMI issues for both existing systems and future systems. This system 10 and method 400 are designed to cancel adverse effects of the wireless charging signal 104 so regardless of the remote control technology being implemented, the system 10 and method 400 cancel the EMI caused by the wireless charging signal 104.

The system 10 and method 400 also solve the interference issues for vehicles parked adjacent to the wireless charging system 100 in use. Many of the proposed solutions for wireless charging system interference discussed in the Background of the Invention only solve the issue on the vehicle utilizing the wireless charging system 100 and not for vehicles parked adjacent to the wireless charging system 100 in operation.

The system 10 actively adapts to changes in the charging signal's fundamental frequency by constantly monitoring and correcting for any variations in the frequency. The charging signal's fundamental frequency may vary during the charge cycle due to temperature changes, resonant tuning of wireless charging system, component drift, etc.

The system 10 and method 400 are compatible with all proposed wireless charging system fundamental frequencies.

The system 10 may be cost effective because the system 10 can utilize low cost, off the shelf electronics and can utilize existing on-vehicle remote control transducers.

While this invention has been described in terms of the preferred embodiments thereof, it is not intended to be so limited, but rather only to the extent set forth in the claims that follow. Moreover, the use of the terms first, second, etc. does not denote any order of importance, but rather the terms first, second, etc. are used to distinguish one element from another. Furthermore, the use of the terms a, an, etc. do not denote a limitation of quantity, but rather denote the presence of at least one of the referenced items.

We claim:

1. A system configured to mitigate electromagnetic interference generated by a source resonator of a wireless charging system, said system comprising:
a receiver configured to receive a wireless charging signal transmitted by the source resonator;
a phase shifter in communication with said receiver and configured to generate a canceling signal that is 180° out of phase with the wireless charging signal currently received by the receiver; and
a transmitter in communication with the phase shifter and configured to electromagnetically transmit the canceling signal, thereby canceling at least a portion of the wireless charging signal.

2. The system in accordance with claim 1, wherein the system further determines a fundamental frequency of the wireless charging signal and wherein a frequency of the canceling signal is based on the fundamental frequency of the wireless charging signal currently received by the receiver.

3. The system in accordance with claim 1, wherein the transmitter is a dedicated transmitter configured to transmit only the canceling signal.

4. The system in accordance with claim 3, wherein the transmitter is disposed within a vehicle.

5. The system in accordance with claim 3, wherein the transmitter is disposed within the wireless charging system.

6. The system in accordance with claim 1, wherein the transmitter is a transceiver of a remote control system configured to transmit the canceling signal and well as transmit and receive remote control signals.

7. The system in accordance with claim 6, wherein the transmitter is disposed within a vehicle.

8. A system to mitigate electromagnetic interference generated by a source resonator of a wireless charging system, said system comprising:
a receiver receiving a wireless charging signal transmitted by the source resonator;
a phase shifter in communication with said receiver and generating a canceling signal that is 180° out of phase with the wireless charging signal currently received by the receiver; and
a transmitter in communication with the phase shifter and electromagnetically transmitting the canceling signal, thereby canceling at least a portion of the wireless charging signal.

9. The system in accordance with claim 8, wherein the system further determines a fundamental frequency of the wireless charging signal and wherein a frequency of the canceling signal is based on the fundamental frequency of the wireless charging signal currently received by the receiver.

10. The system in accordance with claim 8, wherein the transmitter is a dedicated transmitter configured to transmit only the canceling signal.

11. The system in accordance with claim 10, wherein the transmitter is disposed within a vehicle.

12. The system in accordance with claim 10, wherein the transmitter is disposed within the wireless charging system.

13. The system in accordance with claim 8, wherein the transmitter is a transceiver of a remote control system configured to transmit the canceling signal and well as transmit and receive remote control signals.

14. The system in accordance with claim 13, wherein the transmitter is disposed within a vehicle.

15. A method to mitigate electromagnetic interference generated by a source resonator of a wireless charging system, said method comprising the steps of:
receiving a wireless charging signal transmitted by the source resonator;
generating a canceling signal that is 180 degrees out of phase with the wireless charging signal that is currently being received; and
electromagnetically transmitting the canceling signal, thereby canceling at least a portion of the wireless charging signal.

16. The method in accordance with claim 15, wherein the method further includes the step of determining a fundamental frequency of the wireless charging signal and wherein the canceling signal is transmitted at a canceling signal frequency that is based on the fundamental frequency of the wireless charging signal that is currently being received.
